(19) United States
(12) Patent Application Publication
(10) Pub. No.: US 2008/0122240 A1
(43) Pub. Date: May 29, 2008

(54) Tailgate for a Vehicle Comprising an Additional Load Carrier

(76) Inventors: Alain Leroy, Diessen-Dettenschwang (DE); Heinz Pschorn, Dachau (DE); Robert Braun, Berg (DE); Dirk Legler, Well (DE); Michael Koelbl, Neuried (DE); Oliver Vogt, Muchen (DE); Thomas Rudolph, Hechendorf (DE); Thomas Jakimenczuk, Hohenkirchen (DE)

Correspondence Address: DICKINSON WRIGHT PLLC, 1901 L. STREET NW, SUITE 800, WASHINGTON, DC, 20036, US

(21) Appl. No.: 11/908,376

(22) PCT Filed: Mar. 10, 2006
(86) PCT No.: PCT/DE06/00442

§ 371 Date: Oct. 23, 2007

(30) Foreign Application Priority Data
Mar. 11, 2005 (DE) 10 2005 011 680.9

(51) Int. Cl. B60R 5/04

(52) U.S. Cl. 296/37.6

(57) ABSTRACT

The invention relates to a tailgate for a vehicle, said tailgate comprising an additional load carrier which is arranged in such a way that it can be pivoted or tilted about an axis in relation to the tailgate, and comprises at least one loading surface arranged approximately horizontally in an outwardly pivoted position. The load carrier (10) also comprises at least one tiltable wall (12) which is connected, at a rigid approximately right angle, to the loading bottom (11) which is approximately horizontally positioned in the outwardly pivoted position, said tiltable wall being located inside the loading region of the vehicle, in the inwardly pivoted position of the load carrier.

The present invention relates to a tailgate for a motor vehicle in which an additional cargo carrier is integrated into the tailgate, said cargo carrier being pivotable and/or tiltable with respect to the tailgate about an axis and having at least one loading surface for the cargo which is approximately horizontally positioned in an outwardly pivoted position.

Tailgates for vehicles are known from the state of the art, where an additional cargo carrier is integrated into the tailgate. For example, DE 44 24 611 describes a vehicle having a tailgate in which another pivotable gate is integrated into the tailgate, the latter gate being outwardly pivotable into an approximately horizontal use position and means for fastening various loads such as profiled rails being arranged on the top side of the outwardly pivoted gate and a holding rod so that bicycles can be transported on the outwardly pivoted surface. In the closed position, this cargo carrier is integrated into the tailgate in such a way that its outside is flush with the frame of the tailgate. However, the tailgate is designed with two walls, the closed cargo carrier forming an outside wall and another inside wall also being formed on the interior of the tailgate, closing the actual stowage space in the interior of the vehicle with respect to the outside. It is thus impossible to use the cargo carrier to create transport goods [sic; cargo space?] in the interior of the vehicle because the tailgate remains closed in both positions of the cargo carrier.

DE 42 31 568 A1 describes a baggage holder for motor vehicles in which an outwardly pivotable gate is integrated into a tailgate in a similar manner. Here again, the tailgate itself remains closed when the gate that serves as the additional cargo carrier is pivoted outward, so the cargo space is not accessible. According to an alternative variant, a bumper unit can be extracted toward the rear, thereby lengthening the vehicle and creating an additional cargo carrier.

U.S. Pat. No. 1,588,740 describes a cargo carrier that can be pulled out toward the rear, thereby lengthening the rear area. With this invention, an extended loading surface and an additional cargo space are created in the rear end area. First, an ordinary trunk lid is pivoted upward. Then the box-like cargo carrier is pulled outward like a drawer, and there is an additional rounded door which lengthens the trunk lid toward the rear when the trunk is closed. This additional door is pivotable and can be pivoted toward the rear. By inserting the box after loading, it is possible to introduce cargo into the trunk area. However, this principle cannot readily be applied to vehicles having a tailgate, which usually pivots about an axis in the upper area, unlike a trunk lid in a vehicle with a notchback. With this known approach, the trunk lid is opened when the cargo carrier is extracted and the extracted position is not usually available when driving. Furthermore, there is also the risk of exhaust gases entering the interior of the vehicle.

U.S. Pat. No. 5,975,610 A1 describes a trailer for a vehicle with a downwardly pivotable rear wall for the loading surface. When this rear wall is pivoted outward into a horizontal position, it can be used as a seating surface. To this end, a seating element with a seat backrest and a seat surface can be mounted on the rear wall of the loading surface. When the rear wall is pivoted into the closed vertical position, the seat pivots with this rear wall into an out-of-use position in which it remains inside the cargo space. First, this known device serves only specifically as a seating element and should be usable as such only when the trailer is parked, e.g., at a stop. Use during driving for transportation of people is out of the question for safety reasons. Furthermore, this is a trailer with a loading surface that is open at the top and is used exclusively for cargo purposes and is not a vehicle in which people can be transported in the interior. This publication does not give any suggestion about integrating a pivotable or tiltable element into the tailgate of a motor vehicle.

DE 36 10 777 A1 describes a passenger vehicle having a tailgate compartment integrated laterally into the space between the bumper and the rear wheel house. This tailgate compartment serves as a stowage space for objects such as on-board tools, fire extinguisher, pare parts or the like that are carried in the vehicle but are needed only certain cases. A console on which the tailgate compartment is pivotably mounted is provided on a vehicle frame running laterally in the longitudinal direction. To open the gate, the tailgate compartment is pivoted downward in a tilting movement. In the closed position, the tailgate compartment is inside the contour of the vehicle chassis. However, the tailgate has no connection to the interior or cargo space of the vehicle. This is a vehicle with a notchback in which the cargo space is sealed by an ordinary trunk lid. It is impossible for the tailgate compartment to convey cargo into the interior of the trunk space. The tilt design of the tailgate compartment is also arranged laterally and at a much lower level and in a different area than the trunk lid.

The object of the present invention is to make available a trunk lid for a motor vehicle in which an additional cargo carrier is integrated into the tailgate, easily and rapidly facilitating the stowage of cargo in the interior of the vehicle and/or the unloading of cargo out of the interior of the vehicle without opening the tailgate of the vehicle. The solution to this problem is provided by an inventive tailgate for a vehicle of the generic type defined in the preamble and having the characterizing features of the main claim.

According to this invention, the cargo carrier integrated into the tailgate comprises a swivel wall in addition to the loading bottom which is positioned approximately horizontally in the outwardly pivoted position, said swivel wall being connected to the loading bottom and a rigid angle, preferably approximately a right angle, such that when this swivel wall is in the inwardly pivoted position of the cargo carrier, it is inside the cargo space of the vehicle. This swivel wall in the inwardly pivoted position of the cargo carrier preferably forms an approximately horizontal surface for the cargo in the interior of the cargo space of the vehicle. The outside of the loading surface of the cargo carrier is preferably approximately flush with the plane of the tailgate in the inwardly pivoted position of the cargo carrier.

The cargo carrier designed according to the present invention can be pivoted outward when the tailgate of the vehicle is swiveled outward in a pivoting movement, so that then the loading bottom assumes an approximately horizontal position. The cargo can then be deposited on this loading bottom and then the entire cargo carrier can be tilted into the inwardly pivoted position, preferably in a pivoting movement of approximately 90°. Therefore, the cargo which has previously been positioned approximately horizontally comes into the plane of the tailgate, while the swivel wall moves into the interior of the cargo space of the vehicle. Then the cargo previously deposited on the cargo carrier is pivoted together with the latter inward into the interior of the cargo space. In other words, in this pivoting movement, the cargo moves through the plane of the tailgate, whereby the tailgate remains in its closed position during this process. In the final position, the cargo is in the interior of the cargo space in contact with the swivel wall which then preferably forms an approximately horizontal loading surface. If the cargo is to be unloaded again the pivoting movement is in the opposite direction so that the cargo is then again on the loading bottom of the cargo carrier when in the outwardly pivoted position. The inventive approach has the special advantage that heavy or bulky cargo, for example, can be stowed much more easily in the interior (cargo space) of the vehicle. This loading operation can take place without opening the tailgate, which has the advantage, for example, that the vehicle can be loaded conveniently even when the engine is running, for example, without exhaust gas entering the interior of the vehicle. In the outwardly pivoted position of the cargo carrier, the opening in the tailgate is sealed by the swivel wall. In the inwardly pivoted position, the outside of the side of the gate forming the loading surface is closed. After the loading operating, the cargo is accessible from the interior of the vehicle, if necessary, unlike the situation with the known approaches from the prior art. Handling in the pivoting movement of the cargo carrier for loading and unloading is also very convenient. In the loading operation, the cargo undergoes a 90° pivoting movement together with the cargo carrier, but this is not problematical because the swivel wall and the loading bottom abut against one another, preferably at approximately a right angle, and consequently the cargo in the inwardly pivoted position uses the swivel wall as a supporting surface. If necessary, the cargo is placed on the loading bottom in the hourly pivoted position in such a way that the subsequent 90° movement in the loading operation is taken into account and the cargo is then positioned in the desired upright position when in the inwardly pivoted transport position.

According to a preferred further embodiment of the invention, the cargo carrier also has at least one side wall in addition to the loading surface and the swivel wall, preferably having two side walls which border the cargo space between the loading surface and the swivel wall at the sides. These side walls may also be designed as folding walls, so it is possible to collapse the cargo carrier into a flat, out-of-use position, if necessary, in which the swivel wall lies flatly on the loading surface. In this variant, however, corresponding reinforcing elements such as rods or the like must also be provided to ensure that the side walls are reinforced in the use position and the rigid angle between the swivel wall and the loading bottom is maintained, so that the desired function of the cargo carrier is ensured. According to a further embodiment of the invention, at least one sealing element is provided on the swivel wall and/or on the tailgate, said sealing element forming a seal between the swivel wall and the tailgate and/or a seal with respect to the cargo space of the vehicle when in the outwardly pivoted position of the cargo carrier. Such a sealing element prevents an influx of exhaust gas into the interior of the vehicle when the cargo carrier is pivoted outward.

Furthermore, it is advantageous to lock the cargo carrier by suitable means in the outwardly pivoted position, whereby this locking should ensure that the cargo carrier in this locked position is designed for an adequate weight load due to heavy cargo.

To further simplify the loading process, according to a further embodiment of the invention, it is possible to provide for means to be present, e.g., in the form of at least one spring element to further simplify the closing movement/pivoting function of the cargo carrier out of the outwardly pivoted position into the inwardly pivoted position (closed position) and thus to further simplify the loading operation. These means support the loading operation and the operating person need not exert as much force to move a heavy cargo placed on the loading surface into the cargo space of the vehicle, for example, merely by pivoting the cargo carrier. It is essentially also possible to support this loading operation (pivoting movement), e.g., by motor means or pneumatic means.

In addition, stop means are preferably also provided on the cargo carrier which form an end stop and/or define an inwardly pivoted closed position of the cargo carrier. Furthermore, it is advantage if a lock on the cargo carrier in the inwardly pivoted position is provided to prevent unwanted opening, whereby, for example, a lock for locking and securing the inwardly pivoted cargo carrier may also be provided. As in the case of the tailgate of a vehicle, opening of the cargo carrier may also be triggered by a central lock system operable by a wireless key, for example.

According to one variant of the present invention, it is also possible to provide for the pivoting module not to be a fixed component of the tailgate but instead to be available as a separate part which is placed on a gate-like cargo carrier that can be pivoted out of the tailgate of a vehicle and which is detachably attachable to this cargo carrier.

The features mentioned in the subclaims pertain to additional further embodiments of the inventive approach to solving this problem. Additional advantages of the invention are derived from the following detailed description.

The present invention is described in greater detail below on the basis of an exemplary embodiment with reference to the accompanying drawings, in which

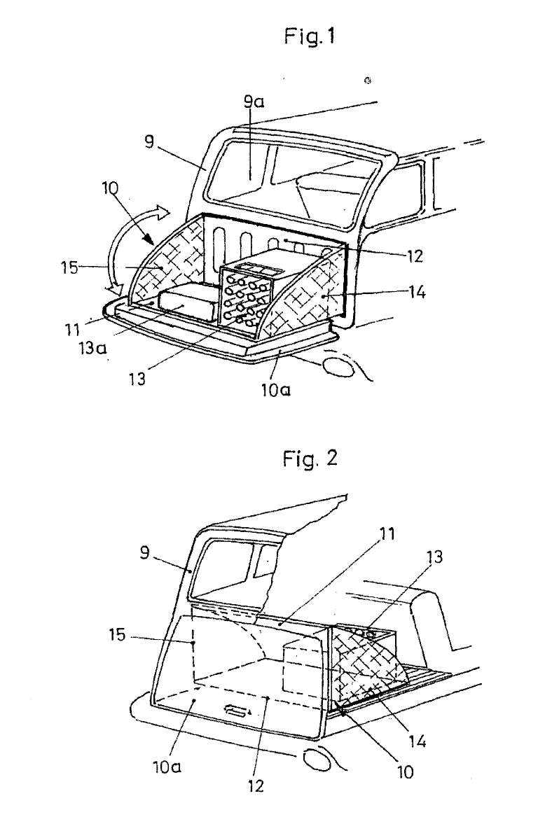

FIG. 1 shows a schematic highly simplified view of a tailgate with the cargo carrier pivoted outward;

FIG. 2 shows a corresponding view with the cargo carrier pivoted inward after the loading operation.

First, reference is made to FIG. 1. FIG. 1 shows in a highly schematic and simplified perspective view a detail from the rear area of a vehicle, which is not shown here. In principle, the tailgate 9 of the vehicle is shown; like a traditional tailgate, it can be pivoted upward about an axis (not shown here) in the upper area of the tailgate to opening it. The rear window 9a, which is enclosed in the frame of the tailgate, is indicated in the diagram according to FIG. 1. The pivotable cargo carrier according to this invention, which is labeled with reference numeral 10 on the whole, is arranged below this rear window. This cargo carrier 10 comprises in principle a gate 10a, which is pivotable outward in the direction of the arrow about a horizontal axis situated in the lower area of the tailgate 9 into the position indicated in FIG. 1, said gate being locked by suitable locking means in the outwardly pivoted use position in a final position which is preferably approximately horizontal. These locking means are not shown in detail in this drawing.

The cargo carrier 10 also comprises a loading bottom 11, i.e., a loading surface onto which cargo 13, 13a can be placed or deposited. A swivel wall 12 is connected to this loading surface 11, side walls 14, 15 preferably also being provided on each of the two sides, bordering a cargo space between the swivel wall 12 on the loading surface 11 at the sides. In the simplest case, this cargo space may correspond in volume approximately to a quarter cylinder, for example, which is an imaginary cylinder having an axis running along the line of contact between the loading bottom 11 and the swivel wall 12. This cargo carrier 10 may be a separate part which is placed on a surface of a gate 10a and secured there. However, the cargo carrier may also be connected to the gate 10a or designed in one part with it and it may comprise a gate, which forms the loading bottom 11 on the inside on which the swivel wall and the two side walls 14 and 15 are mounted.

If the cargo carrier 10 is now pivoted about its axis, out of the outwardly pivoted position shown in FIG. 1, so it pivots inward in the direction of the arrow of the tailgate 9, then the swivel wall 12, which is preferably rigidly connected to a loading surface 11, is moved inward into the cargo space of the vehicle. Then in its preferred end position, the swivel wall 12 is situated in the interior of the vehicle in an approximately horizontal position and the loading surface 11 is approximately in the plane of the lower are of the tailgate 9 and thus is in an approximately vertical position. In this pivoting movement, i.e., tilting movement, the cargo 13, 13a previously placed or deposited on the loading bottom 11 is also pivoted to and is tilted by approximately 90°, so that the cargo 13, 13a, which is subsequently in the interior of the cargo space, is situated on the swivel wall 12, which is then arranged approximately horizontally after the pivoting movement of the cargo carrier 10. The swivel wall 12 thus serves more or less as a loading surface in the interior of the cargo space of the vehicle. It is important here that in this pivoting process, the tailgate 9 can remain in its closed position. One may thus also complete the reverse process by, for example, first placing cargo 13 on the swivel wall 12, e.g., when the cargo carrier 10 is pivoted inward from the interior of the vehicle, as illustrated in FIG. 2, and then pivoting the cargo carrier by an angle of 90°, for example, into its end position, where it is preferably locked. The cargo 13 again completes this pivoting movement along with the cargo carrier or the swivel wall and is then in contact with the loading surface 11 and can be removed from the outside to unload the vehicle. The swivel wall 12 here is then in the plane of the tailgate 9 and forms a seal with respect to the interior of the vehicle. If necessary, sealing elements may be provided on the swivel wall 12 and/or in the area of the tailgate 9 adjacent to the periphery of the swivel wall for this purpose to improve the sealing effect. This makes it possible to prevent exhaust gases from penetrating into the interior of the vehicle, for example, even when the cargo carrier 10 is pivoted outward. The approach according to this invention also has the advantage that heavy or bulky cargo, in particular can also be loaded into the vehicle. For example, it is also conceivable for heavy cargo to be deposited on the loading surface 11 with auxiliary equipment when the cargo carrier 10 is in the outwardly pivoted position and then for the cargo to be moved the cargo space of the vehicle by pivoting the cargo carrier inward. According to a preferred variant of this invention, the force to be applied by the person loading the vehicle may then be further reduced by providing suitable means for supporting the pivoting movement of the cargo carrier. These additional means may include, for example, spring elements or gas compression springs; or motorized support may optionally also be provided.

### LIST OF REFERENCE NUMERALS

9 Tailgate
9a Rear window
10 Cargo carrier
10a Outwardly pivotable gate
11 Loading bottom
12 Swivel wall
13 Cargo
13a Cargo
14 Side wall
15 Side wall

1. Tailgate for a motor vehicle in which an additional cargo carrier is integrated into the tailgate and is arranged to be pivotable and/or tiltable about an axis with respect to the tailgate and to have at least one loading surface for cargo arranged approximately horizontally in the outwardly pivoted position, characterized in that the cargo carrier (10) comprises at least one swivel wall (12) connected to the loading bottom (11) in a rigid angle, approximately a right angle, said loading bottom being positioned approximately horizontally in the outwardly pivoted position, said swivel wall being inside the cargo space of the vehicle when the cargo carrier is in the inwardly pivoted position.

2. Tailgate for a motor vehicle according to claim 1, characterized in that the swivel wall (12) forms an approximately horizontal surface for the cargo in the interior of the cargo space of the vehicle in the inwardly pivoted position of the cargo carrier (10).

3. Tailgate for a motor vehicle according to claim 1 or 2, characterized in that the outside of the loading surface (11) of the cargo carrier (10) is situated approximately flush in the plane of the tailgate (9) when the cargo carrier is in the inwardly pivoted position.

4. Tailgate for a motor vehicle according to any one of claims 1 through 3, characterized in that the swivel wall (12) of the cargo carrier (10) seals the cargo space of the vehicle toward the outside when in the outwardly pivoted position.

5. Tailgate for a motor vehicle according to any one of claims 1 through 4, characterized in that the cargo carrier (10) has a side wall, preferably two side walls (14, 15) arranged on both sides and bordering a cargo space between the loading surface (11) and the swivel wall (12) at the sides.

6. Tailgate for a motor vehicle according to any one of claims 1 through 5, characterized in that at least one sealing element is provided on the swivel wall (12) and/or on the tailgate (9) and seals the cargo space of the vehicle between the swivel wall (12) and the tailgate (9) in the outwardly pivoted position of the cargo carrier (10).

7. Tailgate for a motor vehicle according to any one of claims 1 through 6, characterized in that means are provided for locking the cargo carrier (10) in the outwardly pivoted position.

8. Tailgate for a motor vehicle according to any one of claims 1 through 7, characterized in that means are provided, in particular in the form of at least one spring element, for supporting the closing movement/tilting function of the cargo carrier (10) out of the outwardly pivoted position into the inwardly pivoted position (closed position).

9. Tailgate for a motor vehicle according to any one of claims 1 through 8, characterized in that stop means (17) are provided on the cargo carrier (10), forming an end stop and/or defining an inwardly pivoted closed position of the cargo carrier (10).

10. Tailgate for a motor vehicle according to any one of claims 1 through 9, characterized in that a pivoting module comprising a loading bottom (11) and a swivel wall (12) can be placed on a cargo carrier (10) that can be pivoted out of a tailgate (9) of a motor vehicle and said pivoting module can be detachably attached thereto.

11. Motor vehicle characterized by a tailgate and/or a cargo carrier having the features of any one of claims 1 through 10.
